(19) United States
(12) Patent Application Publication
(10) Pub. No.: US 2020/0384922 A1
(43) Pub. Date: Dec. 10, 2020

(54) WIDE-ANGLE AUXILIARY MIRROR STRUCTURE

(71) Applicant: Kevin Huang, Tainan City (TW)

(72) Inventor: Kevin Huang, Tainan City (TW)

(21) Appl. No.: 16/501,756

(22) Filed: Jun. 5, 2019

(51) Int. Cl. B60R 1/08; G02B 5/10

(52) U.S. Cl. CPC B60R 1/082; G02B 5/10

(57) ABSTRACT

A wide-angle auxiliary mirror includes a lining plate embedded into a concave curved surface of the wide-angle auxiliary mirror and having an outer diameter smaller than that of the wide-angle auxiliary mirror, a convex curved surface protruded from an end of the lining plate and facing the concave curved surface, and the opposite end of the convex curved surface has a plane. The convex curved surface is fixed to the concave curved surface, and a double-sided adhesive is set on the plane for fixing a rearview mirror. Therefore, the convex curved surface and the concave curved surface as well as the plane and the rearview mirror are fixed with each other in a whole-surface-fitting manner, so that the wide-angle auxiliary mirror is fixed onto the rearview mirror securely and integrally.

### BACKGROUND OF THE INVENTION

### Field of the Invention

The present invention relates to a wide-angle auxiliary mirror structure, and more particularly to a wide-angle auxiliary mirror that can be attached to a mirror surface of a rearview mirror with the features of large fixing area and powerful bonding strength.

### Description of the Related Art

In general, a wide-angle auxiliary mirror is fixed onto a rearview mirror for the purpose of assisting and improving the field of vision of the rearview mirror. With reference to FIGS. 1 to 3 for the structure of a conventional wide-angle auxiliary mirror 1, the conventional wide-angle auxiliary mirror 1 has a front side in a circular shape, a cross-section being a curved mirror surface, a convex curved mirror surface 10 on a side of the conventional wide-angle auxiliary mirror 1, a concave curved surface 11 on the other opposite of the side conventional wide-angle auxiliary mirror 1, and a double-sided adhesive 12 adhered to an inner side of the concave curved surface 11 and attached to a curved surface of the concave curved surface 11. When the wide-angle auxiliary mirror 1 is fixed to a rearview mirror 2, the double-sided adhesive 12 of the concave curved surface 11 is adhered to a mirror surface of the rearview mirror 2. Since the wide-angle auxiliary mirror 1 has a curved mirror surface, therefore when the concave curved surface 11 and the rearview mirror 2 are adhered with each other, only an outer edge 120 of the double-sided adhesive 12 is attached to the rearview mirror 2 (as shown in FIG. 3), so that the bonding area is small and the fixing effect is poor. As a result, the wide-angle auxiliary mirror 1 often falls off.

With reference to FIGS. 4 and 5 for another conventional wide-angle auxiliary mirror 3, the wide-angle auxiliary mirror 3 has a front side in a square shape, a cross-section being a curved mirror surface, a convex curved mirror surface 30 on a side of the wide-angle auxiliary mirror 3, a concave curved surface 31 on the other opposite side of the wide-angle auxiliary mirror 3, and a double-sided adhesive 32 adhered to an inner side of the concave curved surface 31. When the wide-angle auxiliary mirror 3 in a square shape with four protruding corners is combined with the rearview mirror 4, only the four corners of the wide-angle auxiliary mirror 3 are adhered to the rearview mirror 4 by the double-sided adhesive 32, so that the bonding area is small (as shown in FIG. 5), and the wide-angle auxiliary mirror 3 may fall off from the rearview mirror 4 easily.

With reference to FIGS. 6 and 7 for a further conventional wide-angle auxiliary mirror 5, the conventional wide-angle auxiliary mirror 5 has a mirror housing 50 and a mirror surface 51, and the mirror surface 51 is embedded into a front end of the mirror housing 50, and the rear end of the mirror housing 50 is a plane 500 used for fixing a double-sided adhesive 52. When the wide-angle auxiliary mirror 5 is fixed to a rearview mirror 6, the double-sided adhesive 52 is fixed to the rearview mirror 6. Since the rear end of the mirror housing 50 is a plane, therefore the bonding area between the wide-angle auxiliary mirror 5 and the rearview mirror 6 is large, and a secured combination can be achieved. However, after the wide-angle auxiliary mirror 5 is fixed to the rearview mirror 6, the mirror housing 50 is exposed from a position between the wide-angle auxiliary mirror 5 and the rearview mirror 6, so that the wide-angle auxiliary mirror 5 and the rearview mirror 6 have a frame border (as shown in FIG. 7). Compared with the conventional wide-angle auxiliary mirrors 1, 3, the application of the conventional wide-angle auxiliary mirror 5 has the drawback of lacking of high integrity.

In view of the aforementioned drawbacks of the conventional wide-angle auxiliary mirrors, the inventor of the present invention improved over the prior art and designed a novel wide-angle auxiliary mirror structure to overcome the drawbacks of the prior art.

### SUMMARY OF THE INVENTION

Therefore, it is a primary objective of the present invention to provide a wide-angle auxiliary mirror structure that provides secured connection and high integrity after an auxiliary mirror is combined with a rearview mirror.

The present invention is characterized in that a lining plate is embedded into a concave curved surface of a wide-angle auxiliary mirror, and the lining plate has an outer diameter smaller than that of the wide-angle auxiliary mirror, a convex curved surface protruded from an end of the lining plate and facing the concave curved surface, and a plane defined at the opposite end of the convex curved surface. The convex curved surface is fixed to the concave curved surface, and the plane has a double-sided adhesive disposed thereon and provided for fixing the rearview mirror. Therefore, a whole-surface-fitting adhesion can be achieved between the convex curved surface and the concave curved surface and between the plane and the mirror surface of the rearview mirror, and the wide-angle auxiliary mirror is fixed to the rearview mirror securely. In addition, the wide-angle auxiliary mirror fixed to the rearview mirror has high integrity.

The objects, effects, technical measures, and structure of the present invention will become clearer in light of the following detailed description of illustrative embodiments of this invention described in connection with the drawings.

### BRIEF DESCRIPTION OF THE DRAWINGS

FIG. 1 is a perspective view of a first conventional wide-angle auxiliary mirror and a rearview mirror;

FIG. 2 is an exploded view of the first conventional wide-angle auxiliary mirror and a rearview mirror;

FIG. 3 is a cross-sectional view of the first conventional wide-angle auxiliary mirror and a rearview mirror;

FIG. 4 is an exploded view of a second conventional wide-angle auxiliary mirror and a rearview mirror;

FIG. 5 is a cross-sectional view of the second conventional wide-angle auxiliary mirror and a rearview mirror;

FIG. 6 is an exploded view of a third conventional wide-angle auxiliary mirror and a rearview mirror;

FIG. 7 is a cross-sectional view of the third conventional wide-angle auxiliary mirror and a rearview mirror;

FIG. 8 is an exploded view of a wide-angle auxiliary mirror and a rearview mirror in accordance with a first embodiment of the present invention;

FIG. 9 is a cross-sectional view of a wide-angle auxiliary mirror and a rearview mirror in accordance with the first embodiment of the present invention;

FIG. 10 is an exploded view of a wide-angle auxiliary mirror and a rearview mirror in accordance with a second embodiment of the present invention; and

FIG. 11 is a cross-sectional view of a wide-angle auxiliary mirror and a rearview mirror in accordance with the second embodiment of the present invention.

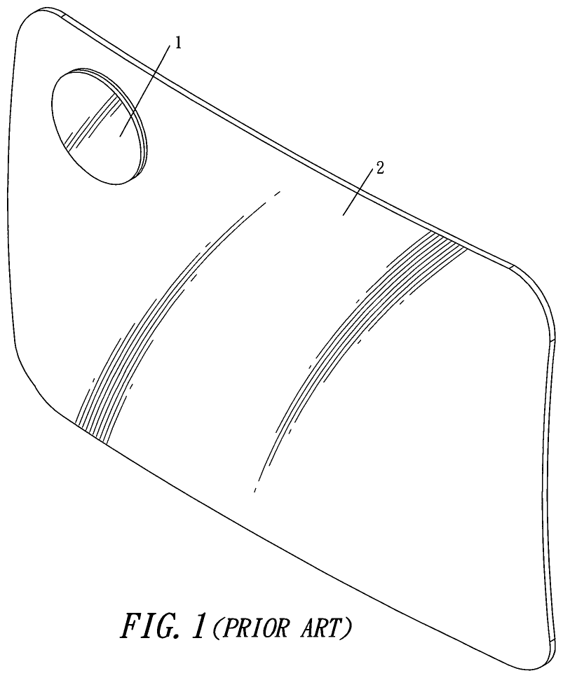

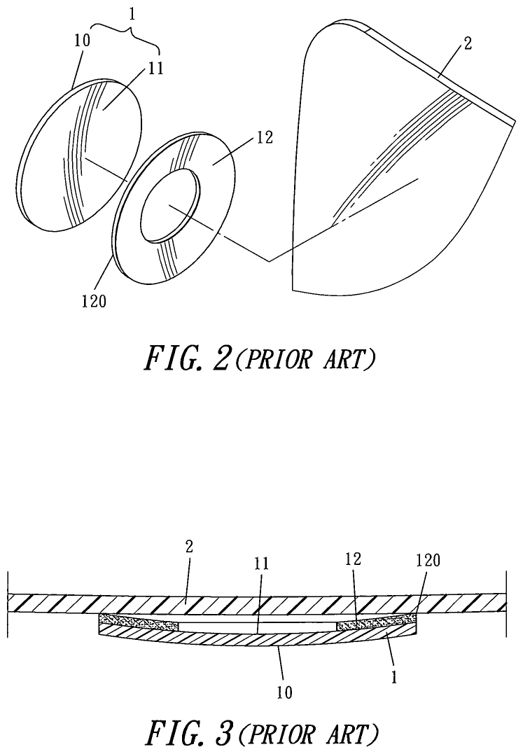

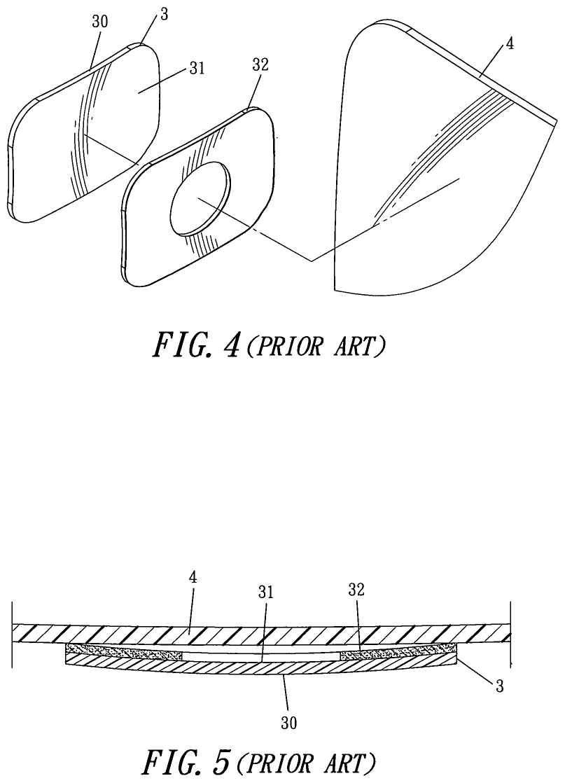

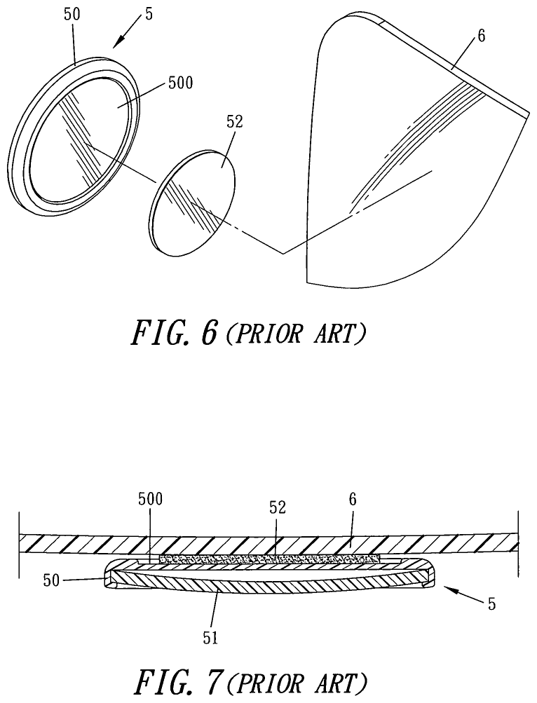

### DETAILED DESCRIPTION OF THE PREFERRED EMBODIMENTS

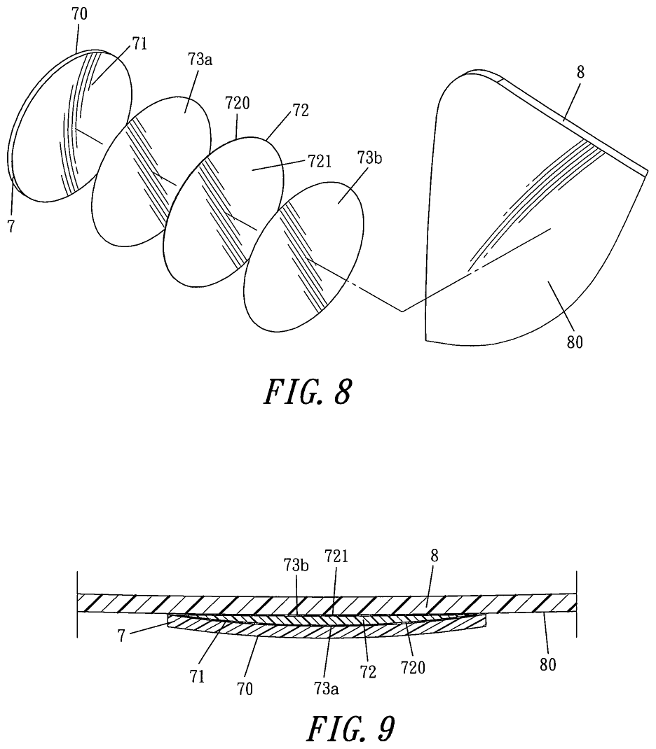

With reference to FIGS. 8 and 9 for a wide-angle auxiliary mirror in accordance with the first embodiment of the present invention, the wide-angle auxiliary mirror 7 is in a circular shape, and has a convex curved mirror surface 70 on one side and a concave curved surface 71 on the other opposite side. A lining plate 72 is embedded into the concave curved surface 71 and has an outer diameter smaller than the outer diameter of the wide-angle auxiliary mirror 7, and a convex curved surface 720 is protruded from an end of the lining plate 72 and facing the concave curved surface 71, wherein the convex curved surface 720 has an outer curvature matched with the inner curvature of the concave curved surface 71, so that the convex curved surface 720 and the concave curved surface 71 can be attached to each other in a whole-surface-fitting manner; and the opposite end of the convex curved surface 720 of the lining plate 72 is a plane 721. Both of the convex curved surface 720 and the plane 721 have a double-sided adhesive tape 73a, 73b separately, and the double-sided adhesive tape 73a is used for adhering the convex curved surface 720 with the concave curved surface 71, and the double-sided adhesive tape 73b is used for adhering the plane 721 with a mirror surface 80 of the rearview mirror 8, so that a whole-surface-fitting adhesion can be achieved between the convex curved surface 720 and the concave curved surface 71 and between the plane 721 and the mirror surface 80 of the rearview mirror 8 (as shown in FIG. 9), and the wide-angle auxiliary mirror 7 can be fixed to the rearview mirror 8 securely. In addition, the wide-angle auxiliary mirror 7 is fixed to the rearview mirror 8 without any frame, so that both of them have high integrity.

Since the outer diameter of the lining plate 72 is smaller than the outer diameter of the wide-angle auxiliary mirror 7, therefore after the double-sided adhesive tape 73b is combined with the mirror surface 80 of the rearview mirror 8, an edge of the wide-angle auxiliary mirror 7 is attached to the mirror surface 80 without any gap, and the wide-angle auxiliary mirror 7 is fixed onto the mirror surface 80 of the rearview mirror 8, and both of them have high integrity.

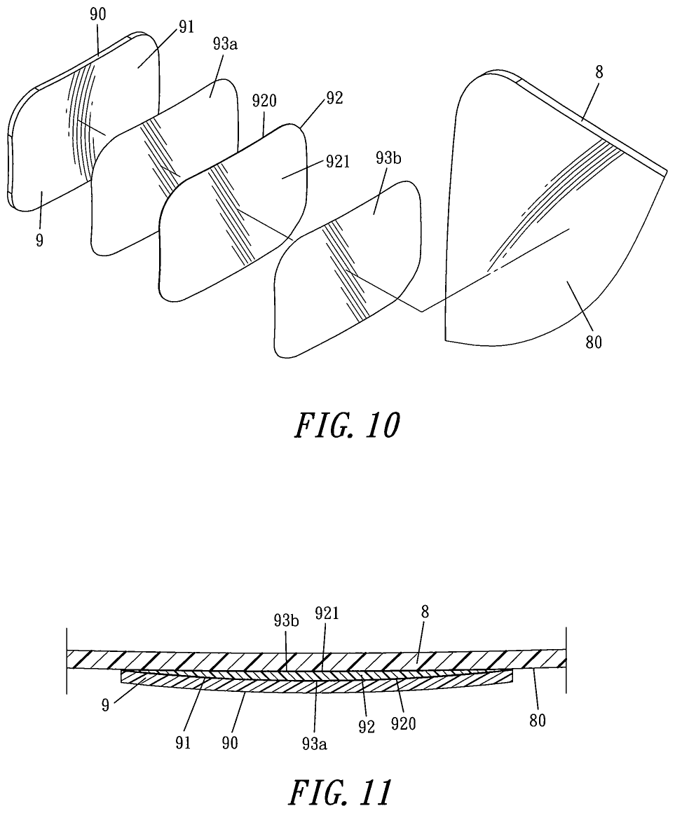

With reference to FIGS. 10 and 11 for a wide-angle auxiliary mirror 9 in accordance with the second embodiment of the present invention, the wide-angle auxiliary mirror 9 is in a square shape, and has a convex curved mirror surface 90 on a side and a concave curved surface 91 on the other opposite side. A lining plate 92 is embedded into the concave curved surface 91, wherein the lining plate 92 has an outer diameter smaller than that of the wide-angle auxiliary mirror 9, and a convex curved surface 920 is protruded from an end of the lining plate 92 and facing the concave curved surface 91, and the convex curved surface 920 has an outer curvature matched with an inner curvature of the concave curved surface 91, so that the convex curved surface 920 and the concave curved surface 91 can be attached to each other in a whole-surface-fitting manner. The opposite end of the convex curved surface 920 of the lining plate 92 is a plane 921. Both of the convex curved surface 920 and the plane 921 have a double-sided adhesive tape 93a, 93b separately, and the double-sided adhesive 93a is used to adhere the convex curved surface 920 with the concave curved surface 91, and the double-sided adhesive 93b is used to adhere the plane 921 with the mirror surface 80 of the rearview mirror 8, so that a whole-surface-fitting adhesion can be achieved between the convex curved surface 920 and the concave curved surface 91 and between the plane 921 and the mirror surface 80 of the rearview mirror 8 (as shown in FIG. 11).

The lining plate of the present invention has the effect of fixing the wide-angle auxiliary mirror onto the mirror surface of the rearview mirror more securely, and providing better integrity of the wide-angle auxiliary mirror and the rearview mirror.

In summation of the description above, the present invention complies with the patent application requirements, and is duly submitted to the Patent and Trademark Office for review and granting of commensurate patent rights.

What is claimed is:

1. A wide-angle auxiliary mirror structure, having a convex curved mirror surface on one side and a concave curved surface on the other opposite side, characterized in that a lining plate is embedded into the concave curved surface, and the lining plate has an outer diameter smaller than the outer diameter of the wide-angle auxiliary mirror, and the lining plate has a convex curved surface protruded from an end of the lining plate and facing the concave curved surface and a plane disposed at the opposite end of the convex curved surface; and the convex curved surface is fixed to the concave curved surface, and the plane has a double-sided adhesive disposed thereon for fixing a rearview mirror.

2. The wide-angle auxiliary mirror structure according to claim 1, wherein the convex curved surface has an outer curvature matched with the inner curvature of the concave curved surface, so that the convex curved surface and the concave curved surface can be fixed to each other in a whole-surface-fitting manner.

3. The wide-angle auxiliary mirror structure according to claim 1, wherein the convex curved surface and concave curved surface have another double-sided adhesive adhered and fixed therebetween.
